(19) United States
(12) Patent Application Publication
(10) Pub. No.: US 2022/0119099 A1
(43) Pub. Date: Apr. 21, 2022

(54) Multi-rotor manned aircraft

(71) Applicant: Shuwu Ye, Shenzhen (CN)

(72) Inventor: Shuwu Ye, Shenzhen (CN)

(21) Appl. No.: 17/075,715

(22) Filed: Oct. 21, 2020

(51) Int. Cl. B64C 27/08; B64C 27/20

(52) U.S. Cl. CPC B64C 27/08; B64D 17/80; B64C 27/20

(57) ABSTRACT

The invention discloses a multi-rotor manned vehicle, comprising man-carried cabin, lifting rotor, equipment bin and steering rudder; the upper part of the said man-carried cabin is provided with a window, the bottom edge is provided with a landing gear or taxiing wheels, the outer wall is provided with a cabin door, the outer wall of both sides or the top is provided with a side-push rotor separately, and the back end of the said side-push rotor is provided with a first power device to drive the said side-push rotor; the said lifting rotors are provided of a quantity of at least two, which are arranged side-by-side in parallel around or on both sides of the said man-carried cabin, and the lower end of each said lifting rotor is respectively provided with a second power device to drive the said lifting rotor; the said equipment bin is arranged at the bottom of the said man-carried cabin, in which a power source is provided for the operation of the said first power device and the second power device; the said steering rudder is arranged at the rear or top of the said man-carried cabin. The flight, take-off and landing of the invention is similar to the unmanned aerial vehicle, having the advantages of small and flexible, low altitude and low speed, vertical lifting, economic and practical.

### TECHNICAL FIELD

The invention relates to the technical field of vehicles, in particular to a multi-rotor manned vehicle.

### BACKGROUND TECHNOLOGY

Throughout the world, there is almost a blank space for manned vehicles that can be owned and piloted by ordinary people, and the following problems are common in personal manned vehicles researched and developed at home and abroad: (i) it is difficult to operate and control and requires professional personnel to operate; (ii) it flies high and fast and is not suitable for daily traffic of ordinary urban and rural population; (iii) it has a large wingspan and high requirement for take-off and landing sites; (iv) it is complex in design and expensive in price. Therefore, an intelligent vehicle of small and flexible, low-altitude and low-speed, vertical lifting, economic and practical will be the future development direction of personal manned vehicles' era.

### CONTENT OF THE INVENTION

In view of the defects in the existing technology, the invention provides a multi-rotor manned vehicle with flight, take-off and landing similar to the unmanned aerial vehicle, having the advantages of small and flexible, low altitude and low speed, vertical lifting, economic and practical.

A multi-rotor maimed vehicle, comprising a man-carried cabin, lifting rotors, an equipment bin and a steering rudder;

The upper part of the said man-carried cabin is provided with a window, the bottom edge is provided with a landing gear or taxiing wheels, the outer wall is provided with a cabin door, the outer wall of both sides or the top is provided with a side-push rotor separately, and the back end of the said side-push rotor is provided with a first power device to drive the said side-push rotor;

The said lifting rotors are provided of a quantity of at least two, which are arranged side-by-side in parallel around or on both sides of the said man-carried cabin, and the lower end of each said lifting rotor is respectively provided with a second power device to drive the said lifting rotor;

The said equipment bin is arranged at the bottom of the said man-carried cabin, in which a power source is provided for the operation of the said first power device and the second power device;

The said steering rudder is arranged at the rear or top of the said man-carried cabin.

Further, the said man-carried cabin is of a capsule structure with a circular cross section to accommodate a single person, or a strip section to accommodate three people, or a rectangle section to accommodate more than three people, or a boat-shape section to accommodate more than three people.

Further, a parachute is arranged at the top of the said man-carried cabin.

Further, a first guide tube cover is arranged vertically outside the said lifting rotor.

Further, each said lifting rotor is arranged side by side in parallel around or on both sides of the said man-carried cabin and is connected with the outer wall corresponding to the said man-carried cabin by a connecting arm.

Further, a second guide tube cover is arranged horizontally outside the said side-push rotor.

Further, both the said first power device and second power device are driven by engines or electric motors.

Further, when both the said first power device and second power device are driven by engines, the said power source is fuel; when both the said first power device and second power device are driven by electric motors, the said power source is storage battery.

Further, the said landing gear or taxiing wheels is provided with a function of shock absorption.

The beneficial effects of the invention are as follows:

1. Compared with the jet aircraft of existing technology, the invention adopts the lifting rotors to realize vertical take-off/landing and hovering, because the jet aircraft will fall when it goes into a stall, the rotor aircraft can take off/land and hover vertically, so the rotor aircraft is more suitable for daily traffic of ordinary people;

2. Compared with the helicopter of existing technology, the invention adopts at least two lifting rotors to provide lifting force, which is more controllable and safe, because multiple lifting rotors provide more stable lifting force, so the controllability is better, and the safety of multiple lifting rotors is relatively high as one of the lifting rotors fails and the other lifting rotors can continue to provide lifting force;

3. Compared with the helicopter of existing technology, the invention adopts the side-push rotor to provide the side-push power, and the side-push power is relatively strong and the flight speed is easy to control, while the helicopter of the existing technology relies on the rotor inclination angle to produce the side-push power, the invention relies on the side-push rotor installed on both sides or top of the man-carried cabin to provide the side-push power directly;

4. Compared with the helicopter of existing technology, the invention is similar to the design of a closed man-carried cabin installed in the middle of the rotors of a multi-rotor unmanned aerial vehicle, which covers a small area and the takeoff/landing is not subject to site restrictions because of the large wingspan of the helicopter of existing technology, which requires a professional airport for takeoff and landing, while the compact structure of the invention can achieve take-off and landing in a conventional site; at the same time, the projection area of the man-carried cabin and lifting rotor can be optimized to be small enough by calculation to be better suitable for ordinary people; in addition, compared with the existing open personal vehicle, it is more conducive to the safety and comfort of pilots, and more suitable for all-weather flight.

5. Compared with the existing personal vehicle, the lifting rotor of the invention is located around or on both sides of the capsule man-carried cabin, and the gravity center of the vehicle is located below the lifting rotor, which is beneficial to the stable flight of the vehicle;

6. Compared with the existing personal vehicle, the invention adopts steering rudder set at the rear or top of the man-carried cabin, and the steering operation and control of the vehicle is more flexible;

7. Compared with the existing personal vehicle, because the domestic and foreign personal vehicle pursue to fly high and fast, so the cost is expensive, and the ordinary people can not afford it, while the invention has a simple design, pursue smoothness and practicality with relatively low cost, and ordinary people can afford it and it is suitable for daily traffic of ordinary people.

To sum up, the flight, take-off and landing of the invention is similar to the unmanned aerial vehicle, with the advantages of small and flexible, low altitude and low speed, vertical lifting, economic and practical.

### DESCRIPTION OF THE FIGURES

In order to explain more clearly the concrete implementation mode of the invention or the technical scheme in the existing technology, a brief introduction to the figures needed to be used in the description of the concrete implementation mode or existing technical description will be made below. In all figures, similar components or parts are generally identified by similar figure marks. In the figures, the components or parts are not necessarily drawn in accordance with the actual proportion.

FIG. 1 is the front view for Embodiment 1;

FIG. 2 is the vertical view for Embodiment 1;

FIG. 3 is the lateral view for Embodiment 1;

FIG. 4 is the front view for Embodiment 2;

FIG. 5 is the vertical view for Embodiment 2;

FIG. 6 is the lateral view for Embodiment 2;

FIG. 7 is the front view for Embodiment 3;

FIG. 8 is the vertical view for Embodiment 3;

FIG. 9 is the lateral view for Embodiment 3;

FIG. 10 is the front view for Embodiment 4;

FIG. 11 is the vertical view for Embodiment 4;

FIG. 12 is the lateral view for Embodiment 4;

FIG. 13 is the back view for Embodiment 5;

FIG. 14 is the vertical view for Embodiment 5;

FIG. 15 is the lateral view for Embodiment 5;

In the figures, man-carried cabin 1, side-push rotor 2, first power device 3, cabin door 4, lifting rotor 5, second power device 6, window 7, equipment bin 8, landing gear or taxiing wheels 9, steering rudder 10, parachute 11, first guide tube cover 12, second guide tube cover 13.

### SPECIFIC IMPLEMENTATION MODES

The embodiment of the technical scheme of the invention is described in detail below in conjunction with the figures. The following embodiments are only used to explain the technical scheme of the invention more clearly, so they are only used as examples and cannot be used to limit the protection scope of the invention.

It should be noted that, unless otherwise stated, the technical or scientific terms used in this application shall be the usual meaning understood by the technical personnel in the field to which the invention belongs.

### Embodiment 1

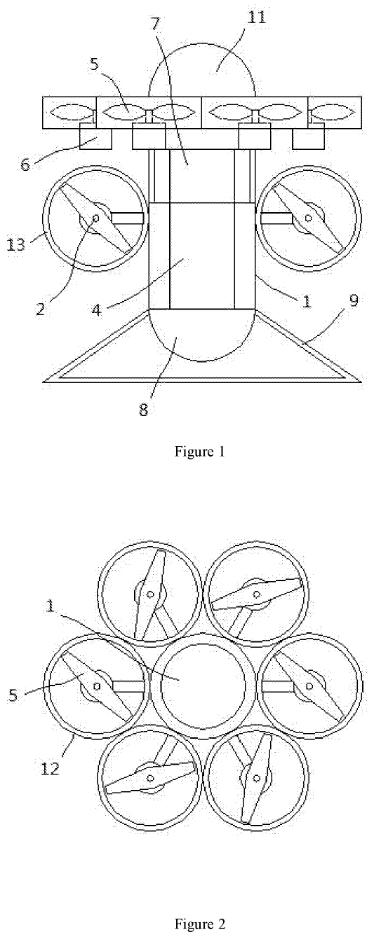

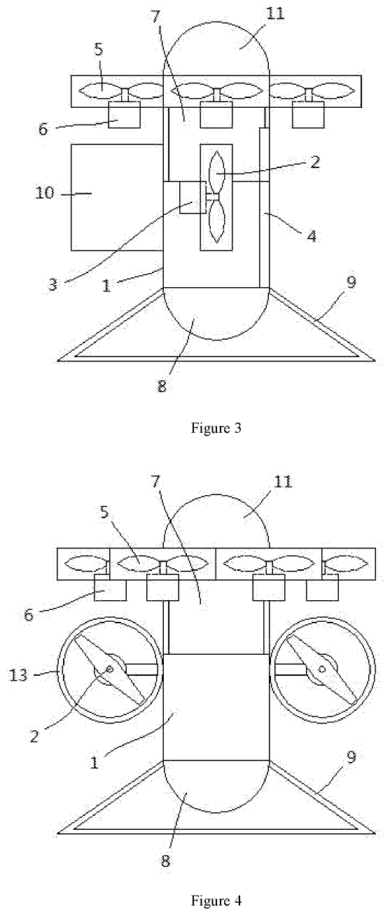

As shown in FIG. 1, FIG. 2 and FIG. 3, a multi-rotor manned vehicle, comprising man-carried cabin 1, lifting rotor 5, equipment bin 8 and steering rudder 10;

The upper part of the said man-carried cabin 1 is provided with a window 7, the bottom edge is provided with a landing gear 9, the outer wall is provided with a cabin door 4, the outer wall of both sides is provided with a side-push rotor 2 separately, and the back end of the said side-push rotor 2 is provided with a first power device 3 to drive the said side-push rotor 2, the first power device 3 is arranged at the back end of the side-push rotor 2, which is beneficial to the heat dissipation of the power device; in which, the man-carried cabin 1 is of a capsule structure with a circular cross section to accommodate a single person; and the side-push rotor 2 is located below the lifting rotor 5.

The said lifting rotor 5 is provided of a quantity of 6, which are distributed circumferentially on the upper part of the said man-carried cabin 1 and above the said window 7, the lower end of each said lifting rotor 5 is respectively provided with a second power device 6 to drive the said lifting rotor 5, and the second power equipment 6 is arranged at the lower end of the lifting rotor 5 to facilitate the heat dissipation of the power device;

The said equipment bin 8 is arranged at the bottom of the said man-carried cabin 1, in which a power source is provided for the operation of the said first power device 3 and second power device 6; in which both the first power device 3 and second power device 6 adopt electric motors with a power source of storage battery;

The said steering rudder 10 is arranged at the rear of the man-carried cabin 1.

In particular, the top of the said man-carried cabin 1 is provided with a parachute 11, which can ensure the safety of pilots and passengers in emergency situations.

In particular, a first guide tube cover 12 is arranged vertically outside the said lifting rotor 5, to increase the aggregation degree of lifting force produced by the operation of lifting rotor 5, so as to improve the energy utilization of the power source, it can also protect the lifting rotor 5.

In particular, each said lifting rotor 5 is distributed circumferentially on the upper part of the said man-carried cabin 1 and above the said window 7, and is connected with the outer wall corresponding to the said man-carried cabin 1 by a connecting arm, the gravity center of the vehicle is located below the lifting rotor 5, which is beneficial to the stable flight of the vehicle.

In particular, a second guide tube cover 13 is arranged vertically outside the said side-push rotor 2, to increase the aggregation degree of side-push force produced by the operation of side-push rotor 2, so as to improve the energy utilization of the power source, it can also protect the side-push rotor 2.

In particular, the said landing gear 9 is provided with telescopic taxiing wheels to facilitate the short distance transfer of the vehicle before takeoff or after landing.

In particular, the said landing gear 9 is a cover structure with a vertical trapezoidal section, which enhances the overall supporting effect of the landing gear 9 for the vehicle and improves the takeoff and landing stability of the vehicle.

In particular, the upper part of the said man-carried cabin 1 may also not be provided with window 7 and is used for carrying goods.

### Embodiment 2

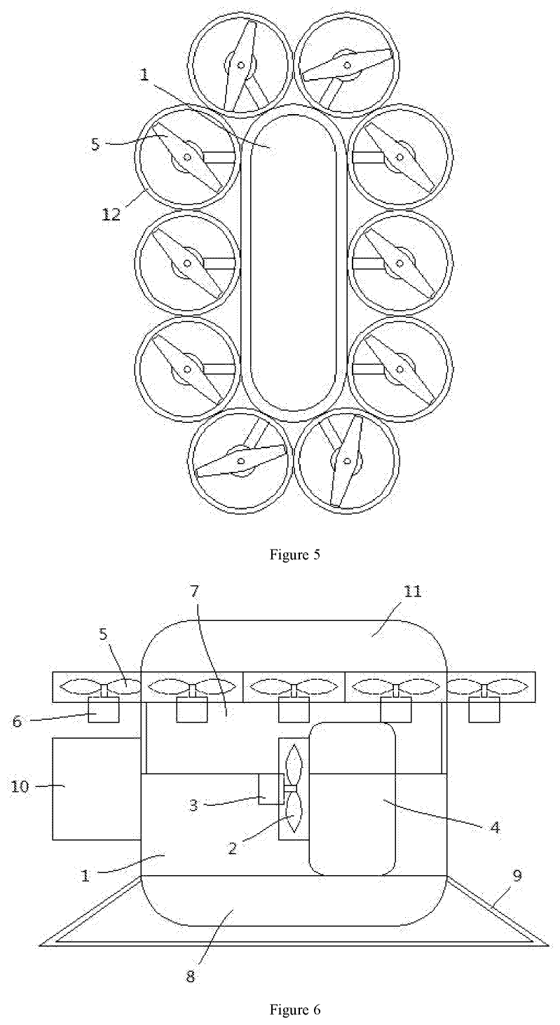

As shown in FIG. 4, FIG. 5 and FIG. 6, the difference from Embodiment 1 is that:

The said man-carried cabin 1 is of a capsule structure, the cross section of which is a strip to accommodate three people, and the lifting rotor 5 is provided of a quantity of 10, which are circumferentially distributed on the upper part of the said man-carried cabin 1 and above the said window 7.

In particular, the said first power device 3 and second power device 6 adopt engines with a power source of fuel.

### Embodiment 3

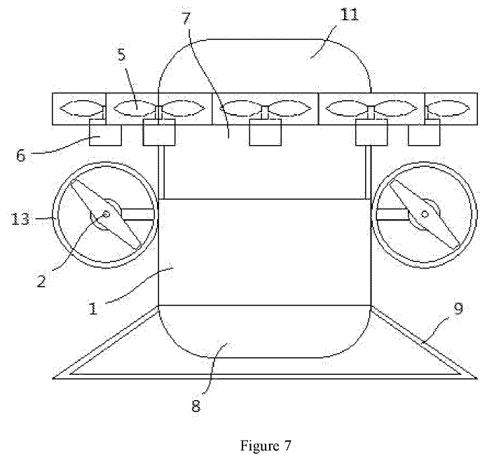

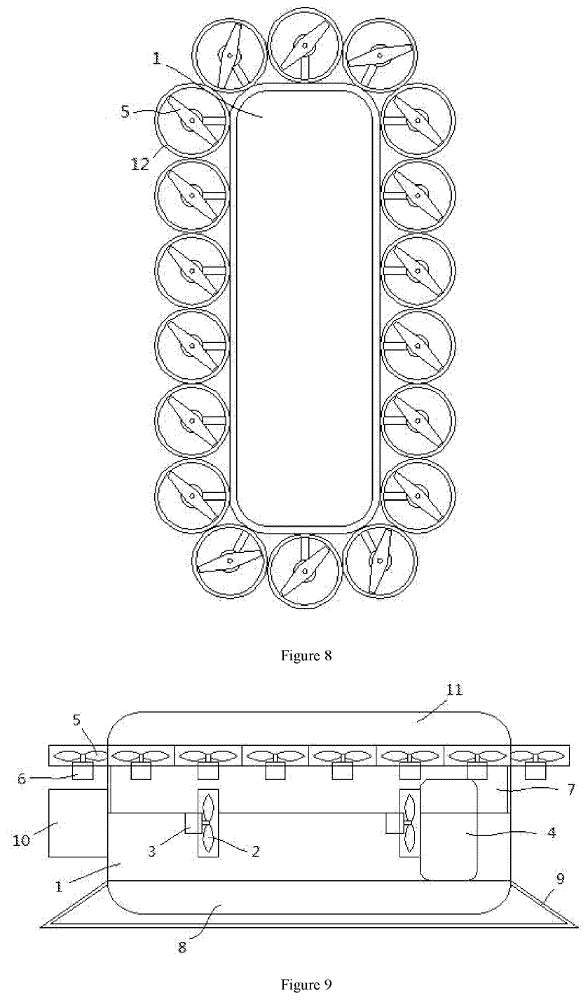

As shown in FIG. 7, FIG. 8 and FIG. 9, the difference from Embodiment 1 is that:

The said man-carried cabin 1 is of a capsule structure, the cross section of which is a rectangle to accommodate more than three people, and the lifting rotor 5 is provided of a quantity of 18, which are circumferentially distributed on the upper part of the said man-carried cabin 1 and above the said window 7; two side-push rotors 2 are arranged respectively on the outer wall on both sides of the man-carried cabin 1, and the two side-push rotors 2 on the same side are located on the same axis.

In particular, the said first power device 3 and second power device 6 adopt engines with a power source of fuel.

In particular, the steering rudder 10 is arranged at the rear of the man-carried cabin 1. When the cabin body of the man-carried cabin 1 is relatively long and wide, the steering rudder 10 can be replaced with a steering rotor when the control effect of the steering rudder 10 is not good, and the cabin steering of the man-carried cabin 1 can be driven by the forward and backward thrust generated by the forward and backward rotation of the steering rotor.

In particular, the landing gear 9 is arranged below the man-carried cabin 1. When the cabin body of the man-carried cabin 1 is relatively long and wide, the landing gear 9 can be replaced with taxiing wheels if the stability of the vehicle itself is good enough, to facilitate a short distance transfer of the vehicle before takeoff and after landing.

### Embodiment 4

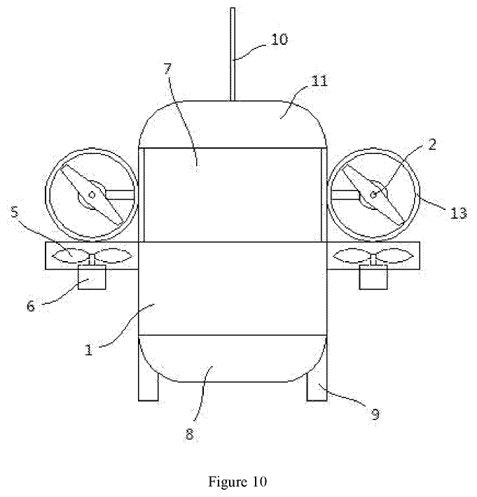

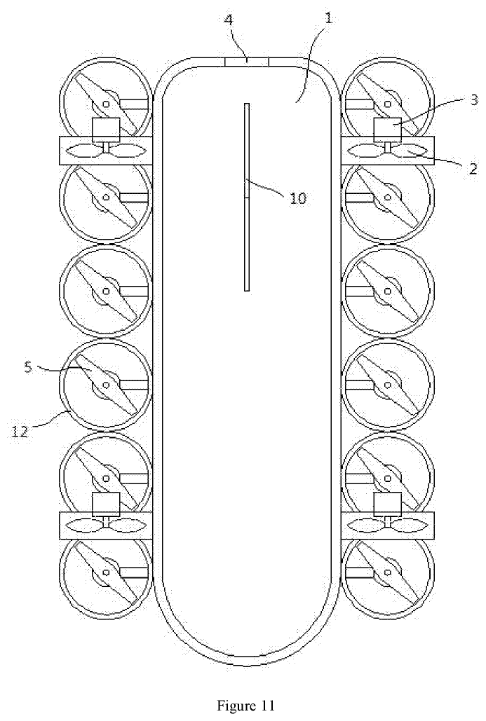

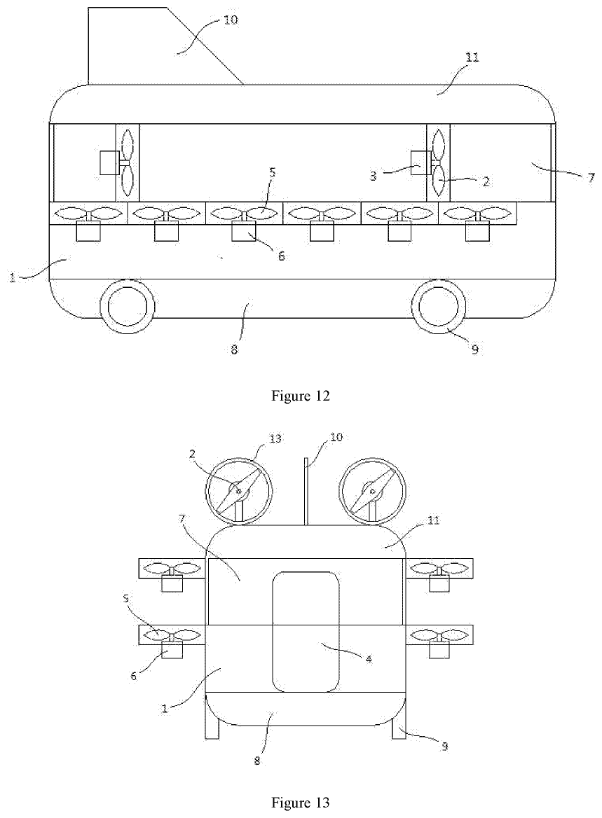

As shown in FIG. 10, FIG. 11 and FIG. 12, the difference from Embodiment 1 is that:

The said man-carried cabin 1 is of a capsule structure, the cross section of which is a boat-shape to accommodate more than three people, and the lifting rotor 5 is provided of a quantity of 12, which are distributed side-by-side in parallel on both sides of the said man-carried cabin 1 and below the said window 7; two side-push rotors 2 are arranged respectively on the outer wall on both sides of the man-carried cabin 1, and the two side-push rotors 2 on the same side are located on the same axis, and the two side-push rotors 2 on the same side are located above the lifting rotor 5.

In particular, the first power device 3 and second power device 6 adopt engines with a power source of fuel.

In particular, the taxiing wheels 9 are provided with a shock absorption function, to facilitate a short distance transfer of the vehicle before takeoff and after landing.

In particular, the steering rudder 10 is arranged on the top of the man-carried cabin 1. When the cabin body of the man-carried cabin 1 is relatively long and wide, the steering rudder 10 can be replaced with a steering rotor when the control effect of the steering rudder 10 is not good, and the cabin steering of the man-carried cabin 1 can be driven by the forward and backward thrust generated by the forward and backward rotation of the steering rotor.

### Embodiment 5

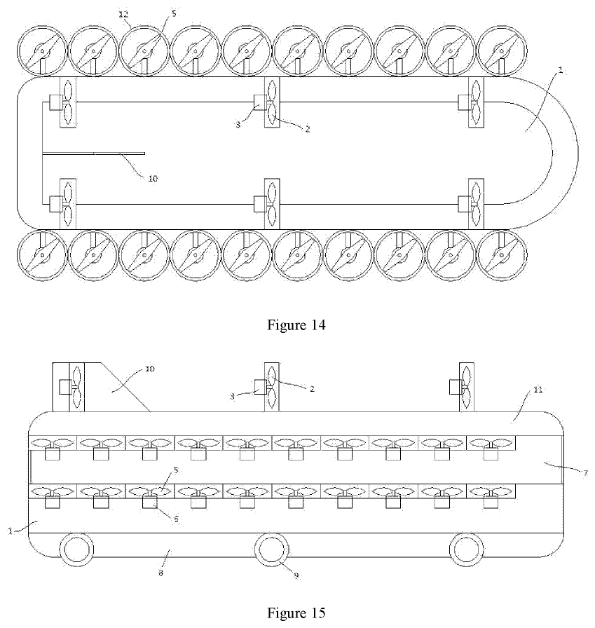

As shown in FIG. 13, FIG. 14 and FIG. 15, the difference from Embodiment 1 is that:

The said man-carried cabin 1 is of a capsule structure, the cross section of which is a boat-shape to accommodate more than three people, and the lifting rotor 5 is provided of a quantity of 40, which are divided into two layers and distributed side-by-side in parallel on both sides of the said man-carried cabin 1 and above and below the said window 7; three side-push rotors 2 are arranged respectively on the top and outer wall on both sides of the man-carried cabin 1, and the three side-push rotors 2 on the same side are located on the same axis, and the three side-push rotors 2 on the same side are located above the lifting rotor 5.

In particular, the said first power device 3 and second power device 6 adopt engines with a power source of fuel.

In particular, the taxiing wheels 9 are provided with a shock absorption function, to facilitate a short distance transfer of the vehicle before takeoff and after landing.

In particular, the steering rudder 10 is arranged on the top of the man-carried cabin 1. When the cabin body of the man-carried cabin 1 is relatively long and wide, the steering rudder 10 can be replaced with a steering rotor when the control effect of the steering rudder 10 is not good, and the cabin steering of the man-carried cabin 1 can be driven by the forward and backward thrust generated by the forward and backward rotation of the steering rotor.

Operation principle of Embodiment 1, Embodiment 2, Embodiment 3, Embodiment 4 and Embodiment 5:

The pilot and passenger enter the man-carried cabin 1 for a travel, and the vehicle is operated and controlled by the pilot or automatic flight program. The flight principle is consistent with the flight principle of the unmanned aerial vehicle. The design of capsule man-carried cabin 1 can reduce the floor area of the vehicle, which can realize the take-off and landing of the vehicle on smaller sites; the gravity center of the vehicle can be reduced through the vertical layout of capsule man-carried cabin 1, thus increasing the stability of the vehicle; the vertical take-off/landing and hovering of the vehicle can be realized by operating and controlling the speed of the lifting rotor 5; and the horizontal flight speed of the vehicle can be controlled by operating and controlling the speed of the side-push rotor 2; the low altitude and low speed flying and vertical take-off/landing of the vehicle can be realized by simultaneously operating and controlling the lifting rotor 5 and the side-push rotor 2; and the flight direction of the vehicle can be changed by adjusting the angle of the steering rudder 10.

Finally, it should be noted that: the above embodiments are used only to describe the technical scheme of the invention, not to restrict it; although the invention is described in detail in the light of the preceding embodiments, the ordinary technical personnel in the field shall understand that: it may still modify the technical scheme recorded in the preceding embodiments or make equivalent replacements for some or all of the technical features; and these modifications or replacements do not separate the essence of the corresponding technical scheme from the technical scheme scope of the embodiment of the invention, and shall be all covered by the protection scope of the claims and specifications of the invention.

The main technical features of the invention are: a closed cabin is arranged in the middle of the geometric plane of the vehicle for carrying people or goods, which is called a man-carried cabin when used for carrying people and called a goods-carried cabin when used for carrying goods. The invention takes a man-carried vehicle as an example, to provide lift power by arranging multiple lifting rotors around or on both sides of the geometric plane of the man-carried cabin side-by side in parallel or circumferentially, except where the arrangement of cabin door is blocked, to provide side-push power by providing side-push rotors on both sides or at the top of the man-carried cabin, to provide steering power by arranging steering rudder or steering rotor at the rear or top of the man-carried cabin, and to facilitate berthing and short distance transfer of the vehicle in a landing state by arranging the landing gear or taxiing wheels at the bottom of the man-carried cabin. The biggest difference from the design of existing manned vehicles is: the lifting rotors provide the lift power, the side-push rotors provide the side-push power, each rotor is provided with a guide tube cover outside, and each guide tube cover is closely connected to the outer wall of the man-carried cabin. The lifting rotors are arranged around or on both sides of the geometric plane of the man-carried cabin, and there is a close connection between the guide tube covers outside each lifting rotor. Thus, the vehicle can obtain a relatively large lifting power under the condition of relatively small projection area. The lifting rotor is located in the middle or upper part of the man-carried cabin, and the gravity center of the vehicle is located below the lifting rotor, which is beneficial to the stable flight of the vehicle.

The man-carried cabin can be designed to be a closed spatial structure of any shape, such as capsule, sphere, ellipsoid, cube, cuboid, cylinder, etc. Taking the shape of an existing vehicle as an example, the man-carried cabin can be designed to resemble the man-carried cabin of an existing aircraft or spacecraft, except that its wings are replaced by lifting rotors; the man-carried cabin can also be designed to resemble the shape of an existing vehicle (e.g. sedan, jeep, min-bus, bus, etc.), except that multiple lifting rotors are arranged around or on both sides of its outer wall side-by-side in parallel or circumferentially to provide the lifting power, and the side-push rotors are arranged on both sides or the top of its outer wall to provide the side-push power. If the vehicle is used for carrying goods, its goods-carried cabin can also be designed to resemble the shape of an existing container or van.

The length of the guide tube cover of the lifting rotor and the side-push rotor along the air flow direction can be determined by calculation according to the need. With the length of the guide tube cover along the air flow direction increasing, the guide tube cover forms an air flow culvert which is beneficial for the air flow to produce stronger thrust. The rotor in the guide tube cover can also be designed as one, two or more groups as required, and the multi-group rotor can produce stronger thrust by coaxial superposition rotation as the engine rotor of the jet aircraft.

The power of the lifting rotors and the side-push rotors can be provided by the power device arranged at the lower end and back end of the rotor, or from the central power equipment, such as the central engine, through a drive shaft.

1. A multi-rotor manned vehicle, characterized by: including man-carried cabin (1), lifting rotor (5), equipment cabin (8) and steering rudder (10);
The upper part of the said man-carried cabin (1) is provided with a window (7), the bottom edge is provided with a landing gear or taxiing wheels (9), the outer wall is provided with a cabin door (4), the outer wall of both sides or the top is provided with a side-push rotor (2) separately, and the back end of the said side-push rotor (2) is provided with a first power device (3) to drive the said side-push rotor (2);
The said lifting rotors (5) are provided of a quantity of at least two, which are arranged side-by-side in parallel around or on both sides of the said man-carried cabin (1), and the lower end of each said lifting rotor (5) is respectively provided with a second power device (6) to drive the said lifting rotor (5);
The said equipment bin (8) is arranged at the bottom of the said man-carried cabin (1), in which a power source is provided for the operation of the said first power device (3) and the second power device (6);
The said steering rudder (10) is arranged at the rear or top of the said man-carried cabin (1).

2. According to the multi-rotor manned vehicle described in claim 1, characterized by: the said man-carried cabin (1) is of a capsule structure with a circular cross section to accommodate a single person, or a strip section to accommodate three people, or a rectangle section to accommodate more than three people, or a boat-shape section to accommodate more than three people.

3. According to the multi-rotor manned vehicle described in claim 1, characterized by: a parachute (11) is arranged at the top of the said man-carried cabin (1).

4. According to the multi-rotor manned vehicle described in claim 1, characterized by: a first guide tube cover (12) is arranged vertically outside the said lifting rotor (5).

5. According to the multi-rotor manned vehicle described in claim 1 or 4, characterized by: each said lifting rotor (5) is arranged side by side in parallel around or on both sides of the said man-carried cabin (1) and is connected with the outer wall corresponding to the said man-carried cabin (1) by a connecting arm.

6. According to the multi-rotor manned vehicle described in claim 1, characterized by: a second guide tube cover (13) is arranged horizontally outside the said side-push rotor (2).

7. According to the multi-rotor manned vehicle described in claim 1, characterized by: both the said first power device (3) and second power device (6) are driven by engines or electric motors.

8. According to the multi-rotor manned vehicle described in claim 7, characterized by: when both the said first power device (3) and second power device (6) are driven by engines, the said power source is fuel; when both the said first power device (3) and second power device (6) are driven by electric motors, the said power source is storage battery.

9. According to the multi-rotor manned vehicle described in claim 1, characterized by: the said landing gear or taxiing wheels (9) is provided with a function of shock absorption.
